(19) United States
(12) Patent Application Publication
(10) Pub. No.: US 2024/0384423 A1
(43) Pub. Date: Nov. 21, 2024

(54) GAS DIFFUSION LAYER AND PREPARATION METHOD THEREFOR

(71) Applicant: QINGKE NEW ENERGY TECHNOLOGY (SHANGHAI) CO., LTD., Anhui (CN)

(72) Inventors: Xuewei MAO, Anhui (CN); Weibing LIN, Anhui (CN); Biao TENG, Anhui (CN)

(73) Assignee: QINGKE NEW ENERGY TECHNOLOGY (SHANGHAI) CO., LTD., Anhui (CN)

(21) Appl. No.: 18/690,268

(22) PCT Filed: Sep. 5, 2022
(86) PCT No.: PCT/CN2022/116942

§ 371 Date: Mar. 8, 2024

(30) Foreign Application Priority Data
Sep. 9, 2021 (CN) 202111056797.3

(51) Int. Cl. C25B 11/032; B21B 1/22; C25B 11/063

(52) U.S. Cl. CPC C25B 11/032; B21B 1/22; C25B 11/063

(57) ABSTRACT

Disclosed are a gas diffusion layer and a preparation method therefor, which comprises the following steps: S1: providing elongated recesses in parallel on a side surface of a metal sheet; S2: cutting the metal sheet provided with the elongated recesses into a desired shape; S3: stacking a plurality of cut metal sheets such that adjacent metal sheets are tightly attached and firmly connected to form a metal block having regular pore structures; and S4: cutting the metal block along a cross section of the metal block, where the cutting thickness matches the thickness of the desired gas diffusion layer, and a cut sheet structure with micropores being regularly distributed on the surface is used as the gas diffusion layer. The present invention can solve the problems that titanium fiber felts in the prior art have poor diversion performance, low contact efficiency and large contact surface resistance.

### TECHNICAL FIELD

The present invention relates to the field of hydrogen production by water electrolysis, in particular to a gas diffusion layer and a preparation method therefor.

### DESCRIPTION OF RELATED ART

Hydrogen production by electrolysis is considered as a new energy storage method and one of the methods to consume renewable energy on a large scale, which has been unanimously recognized in the world. The methods of hydrogen production by electrolysis are mainly divided into the traditional method of hydrogen production by alkaline water electrolysis and the emerging method of hydrogen production by solid polymer electrolyte (SPE) water electrolysis. The hydrogen production by SPE water electrolysis has the advantages of high efficiency, miniaturization of devices, quick start and stop, no pollution and high purity of produced hydrogen, so competitive in the new energy power generation scene with great fluctuation.

The main components of an SPE cell are a bipolar plate, a gas diffusion layer (anode and cathode), and a membrane electrode. The main functions of the gas diffusion layer are to support the membrane electrode, conduct electricity, guide the flow of gas and liquid, etc. Due to the strong oxidizing property of the anodic oxygen evolution reaction during the water electrolysis reaction, the gas diffusion layer and the bipolar plate of the SPE cell are mostly made of titanium. The existing gas diffusion layer for SPE cells mainly adopts a titanium fiber felt, and the titanium fiber felt has the following problems as the gas diffusion layer:

1, the titanium fiber felt is formed by lapping titanium fibers and then sintering, so that the internal voids are scrambled, and the fluid diversion effect is poor; and

2, the surface microstructure of the titanium fiber felt also exhibits a cluttered state, and at the interface making contact with the membrane electrode, the contact efficiency is not high, the contact surface resistance is large, and the efficiency of electrolytic water reaction is affected.

In order to solve the above problems, a new gas diffusion layer with a flat surface and regular pores is required to meet the requirements of contact efficiency and diversion efficiency.

### SUMMARY

The present invention provides a gas diffusion layer and preparation method therefor, which can solve the problems of poor diversion effect, low contact efficiency, and large contact surface resistance of the existing titanium fiber felt.

In order to achieve the above object, in a first aspect, in an embodiment of the present application, the following technical solution is provided: a preparation method for a gas diffusion layer includes the following steps:

S1, providing elongated recesses in parallel on a side surface of a metal sheet;

S2, cutting the metal sheet provided with the elongated recesses formed in step S1 into a desired shape;

S3, stacking a plurality of cut metal sheets in step S2 such that adjacent metal sheets are tightly attached and firmly connected to form a metal block having regular pore structures inside; and

S4, cutting the metal block in step S3 along a cross section of the metal block, where the cutting thickness matches the thickness of the desired gas diffusion layer, and a cut sheet structure with micropores being regularly distributed on the surface is used as the gas diffusion layer.

Preferably, step S1 includes the following steps:

S11, plate roll manufacturing: carving side-by-side grooves on a smooth-surfaced plate roll; and

S12, rolling the metal sheet using the plate roll manufactured in step S11 to machine side-by-side elongated recesses on one side surface of the metal sheet.

Preferably, the grooves on the plate roll are arranged side by side in the axial or circumferential direction of the plate roll.

Preferably, the elongated recesses on the surface of the metal sheet in step S1 are formed by laser machining or etching machining or ultrasonic electric carving machining or electrical discharge machining.

Preferably, the metal sheet is made of titanium or titanium alloy.

Preferably, the preparation method further includes performing surface coating treatment on the gas diffusion layer after step S4, wherein the surface coating treatment is passivation and anticorrosion treatment and hydrophilic treatment.

In a second aspect, in an embodiment of the present application, there is further provided a gas diffusion layer prepared by the preparation method described in the first aspect. Compared with the prior art, the beneficial effects of the present invention are:

By adopting a brand-new preparation method, the preparation method has high efficiency, and a gas diffusion layer with a flat surface and regularly arranged diversion through holes can be prepared, so that the gas diffusion layer can more fully make contact with the membrane electrode, the contact surface resistance is reduced, and the electrolysis efficiency is improved; the diversion efficiency of gas and liquid can be improved to the maximum extent; therefore, the present application is an important innovation to the irregular internal pore structure of the gas diffusion layer used in SPE cells in the past, which can greatly improve the fluid diversion effect of the gas diffusion layer and improve the contact efficiency between the gas diffusion layer and the membrane electrode.

### BRIEF DESCRIPTION OF THE DRAWINGS

FIG. 1 is a flowchart of a preparation method of the present invention;

FIG. 2 is a schematic diagram of the stacking of metal sheets in step S3 in the preparation method of the present invention;

FIG. 3 is a schematic diagram of a metal block formed in step S3 in the preparation method of the present invention;

FIG. 4 is a structural schematic diagram of an embodiment of a gas diffusion layer according to the present invention; and

FIG. 5 is a structural schematic diagram of another embodiment of a gas diffusion layer according to the present invention.

### DESCRIPTION OF THE EMBODIMENTS

The technical solutions in the embodiments of the present invention will be clearly and completely described below in conjunction with the accompanying drawings in the embodiments of the present invention.

In order to achieve the above object, and solve the problem that the conventional titanium fiber felt is poor in diversion effect, low in contact efficiency, and large in contact surface resistance, the present invention provides the following technical solutions.

### Embodiment 1

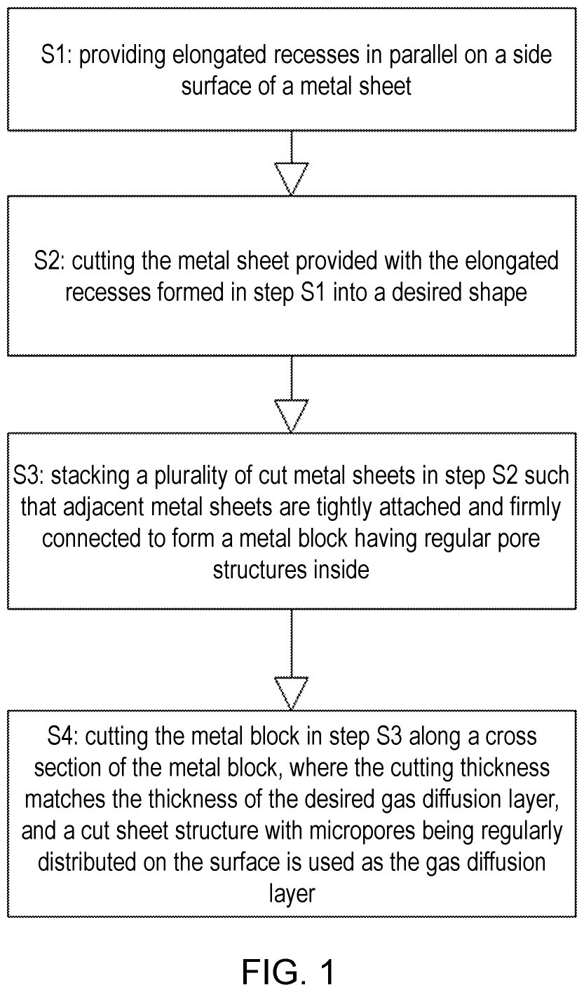

As shown in FIG. 1, a preparation method for a gas diffusion layer is provided and includes the following steps:

Step S1, providing elongated recesses in parallel on a side surface of a metal sheet, wherein the elongated recesses are used to form micropores on the gas diffusion layer, an important indicator of the gas diffusion layer is porosity, which is the ratio of the area of the micropores to the area of the gas diffusion layer, and the size of the elongated recesses and the thickness of the metal sheet will both affect the porosity of the gas diffusion layer. Let the depth of the elongated recesses be a, the width of the elongated recesses be b, the distance between adjacent elongated recesses be c, and the total thickness of the metal sheet be d, by setting the ratio of these four parameters, a gas diffusion layer with a certain porosity can be obtained, such as a: b: c: d=1:1:1:2, the final porosity of the gas diffusion layer is 25%; the four parameters can also be set as a: b: c: d=1:2:2:4, then the final porosity of the gas diffusion layer is 12.5%; further, the four parameters can be set as a: b: c: d=1:1:2:2, then the final porosity of the gas diffusion layer is 12.5%.

In this embodiment, the cross-sectional shape of the elongated recesses has a variety of options, preferably rectangular or square, or semi-circular or triangular or trapezoidal, etc., and those skilled in the art can select different shapes of the elongated recesses according to the specific use requirements of the gas diffusion layer.

In this embodiment, the present application provides a high-efficiency manner of forming the elongated recesses, which is specifically to carve side-by-side grooves on a smooth-surfaced plate roll, and then roll the metal sheet using the prepared plate roll to prepare side-by-side elongated recesses on one side surface of the metal sheet, wherein the grooves on the plate roll are used to form beams between the elongated recesses, and a large number of elongated recesses can be formed at one time by rolling the metal sheet by mounting the surface-carved plate roll on a press roll.

The grooves on the plate roll are arranged side by side in the axial or circumferential direction of the plate roll, and the formation of the elongated recesses can be accomplished by rolling.

Of course, there are many manners of forming the elongated recesses on the metal sheet during practical use, such as laser machining or etching machining or ultrasonic electric carving machining or electrical discharge machining, and those skilled in the art can select the forming manner according to their needs.

In this embodiment, the metal sheet is preferably made of titanium or titanium alloy, and those skilled in the art can also use other metal materials or alloy materials having good corrosion resistance.

Step S2, cutting the metal sheet provided with the elongated recesses formed in step S1 into a desired shape, such as a 200 mm×500 mm rectangular shape, wherein there are many cutting manners, such as die cutting by an edge cutter, or wire electrical discharge machining.

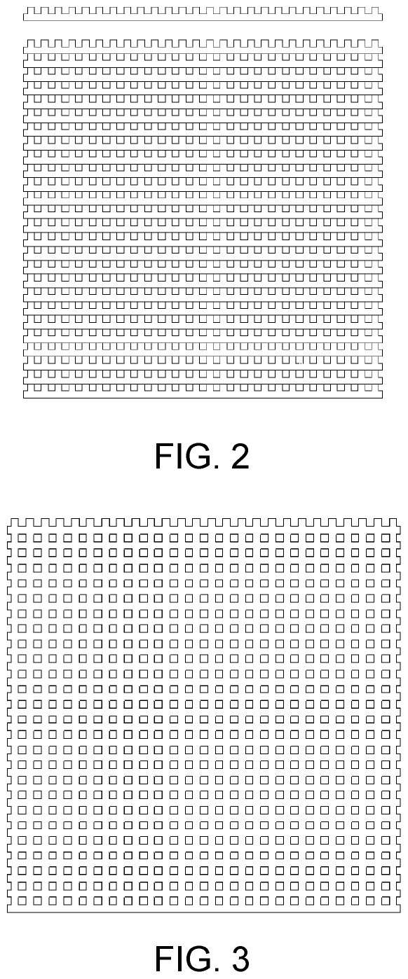

Step S3, as shown in FIGS. 2-3, stacking a plurality of cut metal sheets in step S2, wherein the number of stacked metal sheets can be adjusted according to the requirements of the gas diffusion layer, and adjacent metal sheets are tightly attached and firmly connected, specifically, beams formed by the elongated recesses on the lower metal sheet are tightly attached to the smooth back face of the upper metal sheet, and the metal sheets are firmly connected together by a high-temperature welding process to form a metal block having regular pore structures inside, such as a metal block having a size of 200 mm×500 mm×500 mm. Of course, other manners of connecting the metal sheets can be used in practice, such as ultrasonic welding, resistance welding and laser welding.

Step S4, cutting the metal block in step S3 along a cross section of the metal block,

wherein the cutting thickness matches the thickness of the desired gas diffusion layer, for example, the thickness is 0.5 mm, and a cut sheet structure with micropores being regularly distributed on the surface is used as the gas diffusion layer. When a metal block with the size of 200 mm×500 mm×500 mm is cut, hundreds of gas diffusion layers with specifications of 500 mm×500 mm×0.5 mm can be obtained, and the density of micropores of the formed gas diffusion layer can reach several millions to several billions per square meter, so that the fluid diversion effect is excellent.

After step S4, a step S5 can also be added, specifically, surface coating treatment is performed on the gas diffusion layer, wherein the surface coating treatment is mainly passivation and anticorrosion treatment and hydrophilic treatment.

### Embodiment 2

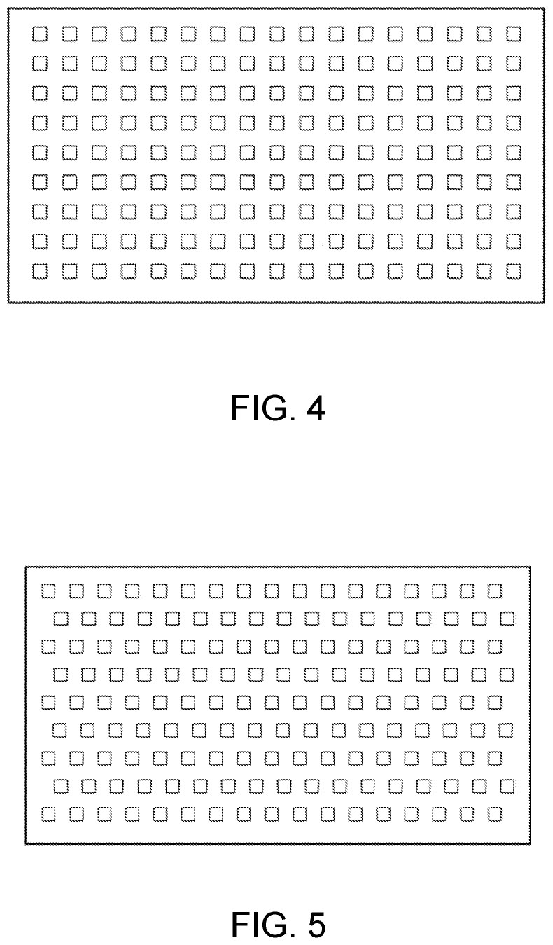

In an embodiment of the present application, the present application provides a gas diffusion layer, as shown in FIG. 4, the gas diffusion layer is prepared by the preparation method described in Embodiment 1, specifically, the gas diffusion layer structurally includes a sheet body, wherein a plurality of micropores running through the sheet body are regularly arranged on the sheet body, and the thickness of the sheet body is preferably in the range of 200 to 800 microns.

The micropores can be arranged in a rectangular array as shown in FIG. 4. Alternatively, the micropores can be arranged in a plurality of rows with the micropores in adjacent rows being staggered as shown in FIG. 5, so that the micropores are more uniform, and the area utilization rate can be improved for the irregular sheet body.

According to the present application, by adopting a brand-new preparation method, the

preparation method has high efficiency, and a gas diffusion layer with a flat surface and regularly arranged diversion through holes can be prepared, so that the gas diffusion layer can more fully make contact with the membrane electrode, the contact surface resistance is reduced, and the electrolysis efficiency is improved; the diversion efficiency of gas and liquid can be improved to the maximum extent; therefore, the present application is an important innovation to the irregular internal pore structure of the gas diffusion layer used in SPE cells in the past, which can greatly improve the fluid diversion effect of the gas diffusion layer and improve the contact efficiency between the gas diffusion layer and the membrane electrode.

In addition, it should be noted that the gas diffusion layer prepared by the method of the present application can also be used in the field of physicochemical reactions, including but not limited to fuel cells, where sufficient fluid dispersion or collection is required, and the performance advantages of the gas diffusion layer of the present application can also be reflected when used in these fields.

It should be noted that all directional indications (such as upper, lower, left, right, front, back, etc.) in the embodiment of the present invention are only used to explain the relative position relationship and movement situation among components in a certain posture (as shown in the drawings), and if the certain posture changes, the directional indications will also change accordingly.

In addition, in the present invention, descriptions such as “first” and “second” are only used for descriptive purposes, and cannot be understood as indicating or implying their relative importance or implicitly indicating the number of indicated technical features. Thus, features defined by “first” and “second” can explicitly or implicitly include at least one of such features. In the description of the present invention, “plurality of” means at least two, e.g., two, three, etc., unless expressly and specifically defined otherwise.

In the present invention, unless otherwise specified and limited, the terms “connection” and “fixation” should be broadly understood. For example, “fixation” can be fixed connection, detachable connection or integrated connection, can be mechanical connection or electrical connection, and can be direct connection, can also be indirect connection through an intermediary, and can be the internal connection of two elements or the interaction between two elements, unless otherwise explicitly defined. The specific meaning of the above terms in the present invention can be understood by a person having ordinary skill in the art according to specific circumstances.

In addition, the technical solutions between the various embodiments of the present invention can be combined with each other, but it must be based on being able to be implemented by a person having ordinary skill in the art, when the combination of the technical solutions contradicts each other or cannot be implemented, it should be considered that the combination of the technical solutions does not exist and is not within the scope of protection claimed in the present invention.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A preparation method for a gas diffusion layer, comprising the following steps:
S1, providing elongated recesses in parallel on a side surface of a metal sheet;
S2, cutting the metal sheet provided with the elongated recesses formed in step S1 into a desired shape:
S3, stacking a plurality of cut metal sheets in step S2 such that adjacent metal sheets are tightly attached and firmly connected to form a metal block having regular pore structures inside; and
S4, cutting the metal block in step S3 along a cross section of the metal block. where a cutting thickness matches a thickness of a desired gas diffusion layer, and a cut sheet structure with micropores being regularly distributed on a surface is used as the gas diffusion layer.

2. The preparation method for a gas diffusion layer according to claim 1, wherein:
step S1 comprises the following steps:
S11, plate roll manufacturing: carving side-by-side grooves on a smooth-surfaced plate roll; and
S12, rolling the metal sheet using the plate roll manufactured in step S11 to machine side-by-side elongated recesses on one side surface of the metal sheet.

3. The preparation method for a gas diffusion layer according to claim 2, wherein the grooves on the plate roll are arranged side by side in an axial or circumferential direction of the plate roll.

4. The preparation method for a gas diffusion layer according to claim 1, wherein the elongated recesses on the surface of the metal sheet in step SI are formed by laser machining or etching machining or ultrasonic electric carving machining or electrical discharge machining.

5. The preparation method for a gas diffusion layer according to claim 1, wherein the metal sheet is made of titanium or titanium alloy.

6. The preparation method for a gas diffusion layer according to claim 1, wherein further comprising performing surface coating treatment on the gas diffusion layer after step S4, wherein the surface coating treatment is passivation and anticorrosion treatment and hydrophilic treatment.

7. A gas diffusion layer, wherein being prepared by the preparation method according to claim 1.
